(19) United States
(12) Patent Application Publication
(10) Pub. No.: US 2025/0287875 A1
(43) Pub. Date: Sep. 18, 2025

(54) MULTI-UNIT HARVESTING MACHINE ALLOWING THE EXECUTION OF SEQUENCES

(71) Applicant: KUHN SAS, Saverne (FR)

(72) Inventors: Elodie ROTH, Haguenau (FR); Fabien ORIEDE, Cosswiller (FR)

(73) Assignee: KUHN SAS, Saverne (FR)

(21) Appl. No.: 19/068,052

(22) Filed: Mar. 3, 2025

(30) Foreign Application Priority Data
Mar. 14, 2024 (FR) FR2402565

(51) Int. Cl. A01D 41/14

(52) U.S. Cl. CPC A01D 41/145

(57) ABSTRACT

A machine includes a right-hand unit and a left-hand unit, a central unit extending between the left-hand unit and the right-hand unit viewed in the working direction, each unit being able to occupy a working configuration and a headland configuration, an interface for inputting command being associated with the machine and connected to a controller for transposing each unit downwards, which means transposing it from the headland configuration to the working configuration, and for transposing each unit upwards, which means transposing it from the working configuration to the headland configuration, the controller being configured to allow execution of a lowering sequence during which each input of a same lowering command transposes at least one of the units downwards, and a lifting sequence during which each input of a same lifting command transposes at least one of the units upwards.

### BACKGROUND OF THE INVENTION

### Field of the invention

The invention relates to the field of agricultural machinery, and in particular to a multi-unit harvesting machine allowing the execution of sequences.

More particularly, the invention relates to a harvesting machine moving in a working direction and including a right-hand unit, a left-hand unit and a central unit extending at least mainly between the left-hand unit and the right-hand unit as seen in the working direction, each unit being able to occupy a working configuration and a headland configuration, an interface for inputting commands being associated with the machine and connected to a controller able to transpose each unit downwards, in other words transpose it from the headland configuration to the working configuration, and able to transpose each unit upwards, in other words transpose it from the working configuration to the headland configuration.

### Description of the Related Art

Document EP3892084A1 discloses a multi-unit harvesting machine, the machine including two left-hand units and two right-hand units and allowing, following the input of a command via the interface, the front right-hand unit to be transposed downwards or upwards and, after a time delay, the rear right-hand unit to be automatically transposed downwards or upwards. In addition, following the input of another command via the interface, the machine allows the front left-hand unit to be transposed downwards or upwards and, after a time delay, the rear left-hand unit to be automatically transposed downwards or upwards. Such a machine makes it possible to reduce the number of commands to be entered by the operator when crossing a boundary between a zone to be worked and a zone to be excluded.

However, a disadvantage of this machine is that the user must, when the machine crosses a boundary between a zone to be worked and a zone to be excluded, simultaneously focus on the choice of the command to be input on the interface and the right moment to transpose each of the front units downwards or upwards, requiring significant dexterity and concentration, meaning that the operator may easily give the wrong command and/or miss the right moment to transpose at least one of these units downwards or upwards. In addition, the time delay between the two units on the same side allows the rear units to be transposed downwards or upwards at the right times only for a specific type of boundary. When this boundary varies, it is necessary to modify the time delay to remain precise in when to transpose the rear units downwards or upwards, and to allow a high quality of work. A poorly configured time delay risks working a zone to be excluded, if transposing the unit upwards too late and/or transposing the unit downwards too soon, and/or leaving a zone to be worked unworked, if transposing the unit upwards too soon and/or transposing the unit downwards too late. Finally, if the midplane of the machine is not aligned with the midplane of the tractor, in particular during turns, the time delay is all the more likely to be inaccurate.

### SUMMARY OF THE INVENTION

The aim of the present invention is to overcome at least some of the aforementioned problems and in particular to relieve the operator when crossing a boundary between a zone to be worked and a zone to be excluded, while at the same time allowing a better quality of work thanks to improved handling of the machine, respectively by transposition of the units downwards and upwards.

To this end, the invention proposes that the controller be configured to execute a lowering sequence during which each input of the same lowering command transposes at least one of the units downwards, and to execute a lifting sequence during which each input of the same lifting command transposes at least one of the units upwards.

### BRIEF DESCRIPTION OF THE DRAWINGS

The invention will be clearer after reading the following description of a preferred variant given by way of example. The description refers to the appended schematic drawings, in which:

FIG. 1 is a top view of a harvesting machine according to the invention;

FIG. 2 is a view of a possible embodiment of an interface of the machine according to the invention;

FIG. 3A, FIG. 3B and FIG. 3C are other views of possible embodiments of the interface of the machine according to the invention;

FIG. 4 is a simplified top view of a harvesting machine preparing to cross a boundary between a worked zone and a zone to be excluded;

FIG. 5 is a simplified side view of the machine in FIG. 1 during which the right-hand, left-hand and central units are in the headland configuration;

FIG. 6 is a simplified top view of a harvesting machine whose unit arrangement is such that the right-hand, left-hand and central units are aligned orthogonally to the working direction.

### DETAILED DESCRIPTION OF THE PREFERRED EMBODIMENTS

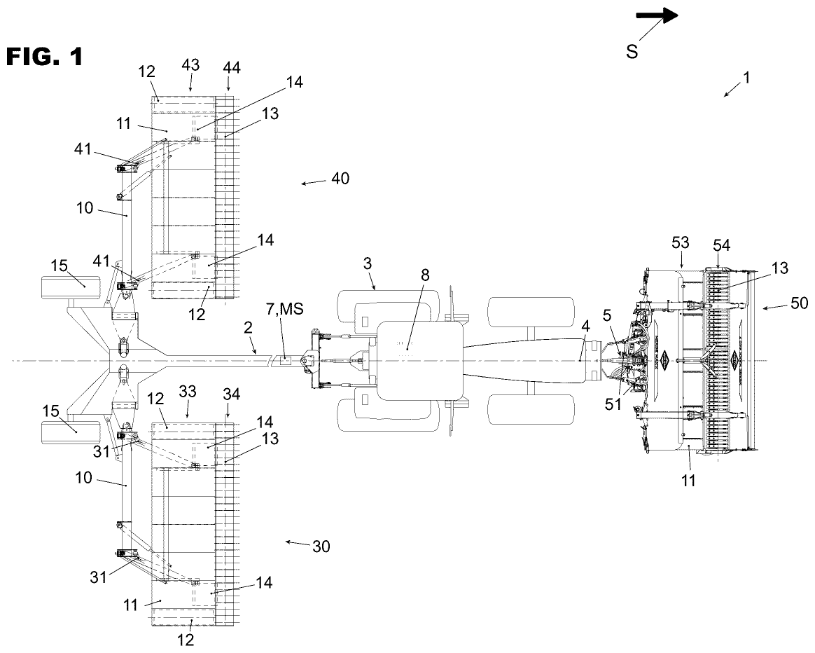

FIG. 1 shows a harvesting machine 1 moving in a working direction S. In this figure, the machine 1 includes a right-hand unit 30, a left-hand unit 40 and a central unit 50. The central unit 50 extends at least mainly between the left-hand unit 40 and the right-hand unit 30 seen in the working direction S, enabling a large width to be harvested with minimal overlap between the central unit 50 and each of the left-hand 40 and right-hand 30 units seen in the working direction S. Each unit 30,40,50 may occupy a working configuration and a headland configuration. The right-hand unit 30 can be moved between the working configuration and the headland configuration by a right-hand actuator 31. The left-hand unit 40 can be moved between the working configuration and the headland configuration by a left-hand actuator 41. Finally, the central unit 50 can be moved between the working configuration and the headland configuration by a central actuator 51.

In the preferred variant, each unit 30,40,50 is associated with a single actuator 31,41,51 for transposing the unit 30,40,50 between the working configuration and the headland configuration. Alternatively, several actuators may be required to transpose a unit 30,40,50 between the working configuration and the headland configuration. Each actuator 31,41,51 can be formed by at least one hydraulic cylinder. Alternatively, the actuators 31,41,51 could be electric and/or pneumatic.

An interface 8 for inputting commands is associated with the machine 1. The interface 8 is connected to a controller 7. The controller 7 can send and receive signals to and from the interface 8. In particular, the interface 8 can send signals to the controller 7 for it to transpose at least one unit 30,40,50 downwards or upwards. In addition, the controller 7 can send signals to the actuators 31,41,51 in order to transpose the associated units 30,40,50 downwards or upwards and/or to valves for actuating these actuators 31,41,51. Actuating one or more actuator(s) 31,41,51 transposes the associated unit(s) 30,40,50 downwards or upwards.

The controller 7 allows each actuator 31,41,51 to transpose the respective unit 30,40,50 downwards. The controller 7 is thus able to transpose each unit 30,40,50 downwards, which means that the controller 7 is able to transpose each unit 30,40,50 from the headland configuration to the working configuration. The controller 7 also allows each actuator 31,41,51 to transpose the respective unit 30,40,50 upwards. The controller 7 is thus able to transpose each unit 30,40,50 upwards, which means that the controller 7 is able to transpose each unit 30,40,50 from the working configuration to the headland configuration.

The right-hand unit 30 is located on the right of the machine 1 seen in the working direction S, and the left-hand unit 40 is on the left of the machine 1. As shown in FIGS. 1, 4, 5 and 6, the machine 1 also includes a chassis 2 connecting at least the right-hand 30 and left-hand 40 units to a tractor 3. Preferably, each of the left-hand 30 and right-hand 40 units is connected to the chassis 2 by a respective support arm 10. As shown in FIG. 1, the chassis 2 is connected to the tractor 3 by the two lower arms of the rear three-point hitch of the tractor 3. As shown in FIGS. 1, 4 and 5, the central unit 50 is connected to the tractor 3 via a front chassis 5 and the front three-point hitch of the tractor 3. Alternatively, the central actuator 51 forms part of the tractor 3 and can be actuated by the controller 7 of the machine 1.

The tractor 3 is used to move the machine 1 in the working direction S, and preferentially also to operate it. The machine 1 could also be self-propelled, the tractor 3 then forming an integral part of the machine 1. The machine 1 has a vertical midplane 4. When the machine 1 moves in a straight line, the midplane 4 is parallel to the working direction S. The midplane 4 also passes through the center of the machine 1 and/or the chassis 2. The machine 1 is substantially symmetrical along the midplane 4. The tractor 3 also has a plane of symmetry coinciding with the midplane 4 in a straight line. An operator drives the tractor 3 and/or the machine 1.

In this document, the concepts “left”, “right”, “front”, “rear”, “side”, “in front” and “behind” are defined while looking in the working direction S. The concepts “inner” and “outer” are defined in relation to the midplane 4. An outer component is further from the midplane 4 than an inner component.

In the working configuration, each unit 30,40,50 rests on the ground of a field, providing support to the chassis 2 and/or the front chassis 5, if applicable. In order to harvest a product, each unit 30,40,50 includes a respective conveyor 34,44,54. Each unit 30,40,50 also includes a respective grouping device 33,43,53. Each grouping device 33,43,53 is designed to move the product in a grouping direction C, preferentially in both directions. Preferably, in the working configuration, each grouping device 33,43,53 extends along the grouping direction C. In particular, each grouping device 33,43,53 may include an auger, partially contained within a shell that guides the product. The auger is preferentially driven around a horizontal axis transverse to the working direction S. Preferably, each grouping device 33,43,53 includes an endless belt stretched between at least two cylinders 12. Each endless belt is preferentially driven by at least one of the cylinders 12. The at least two cylinders 12 are guided in rotation about axes substantially parallel to the working direction S. The product is in particular a plant product, such as grass or straw. Preferentially, the or each grouping direction C is orthogonal to the working direction S.

In the working configuration, each conveyor 34,44,54 is located in front of the grouping device 33,43,53 of the same unit 30,40,50. Each conveyor 34,44,54 is designed to transfer product to the respective grouping device 33,43,53 in a direction parallel to the working direction S. Preferentially, each conveyor 34,44,54 has substantially the same length as the respective grouping device 33,43,53 along the grouping direction C.

In particular, each conveyor 34,44,54 may include at least one mower bar and/or at least one pick-up roller. When the conveyor 34,44,54 includes a mowing bar, it enables mowing of standing plant products. When the conveyor 34,44,54 consists solely of a pick-up roller, it can pick up products, such as mown plants, lying on the ground. Each conveyor 34,44,54 may include a pick-up roller driven in rotation about a respective roller axis 13. Preferentially, each roller axis 13 is perpendicular to the working direction S. Each pick-up roller has fingers distributed around its periphery for picking up product from the ground and transferring it backwards to the respective grouping device 33,43,53. Each pick-up roller is preferably driven by a respective drive motor, electric or preferentially hydraulic. Each pick-up roller could also be driven via the PTO of the tractor 3, like the respective grouping device 33,43,53.

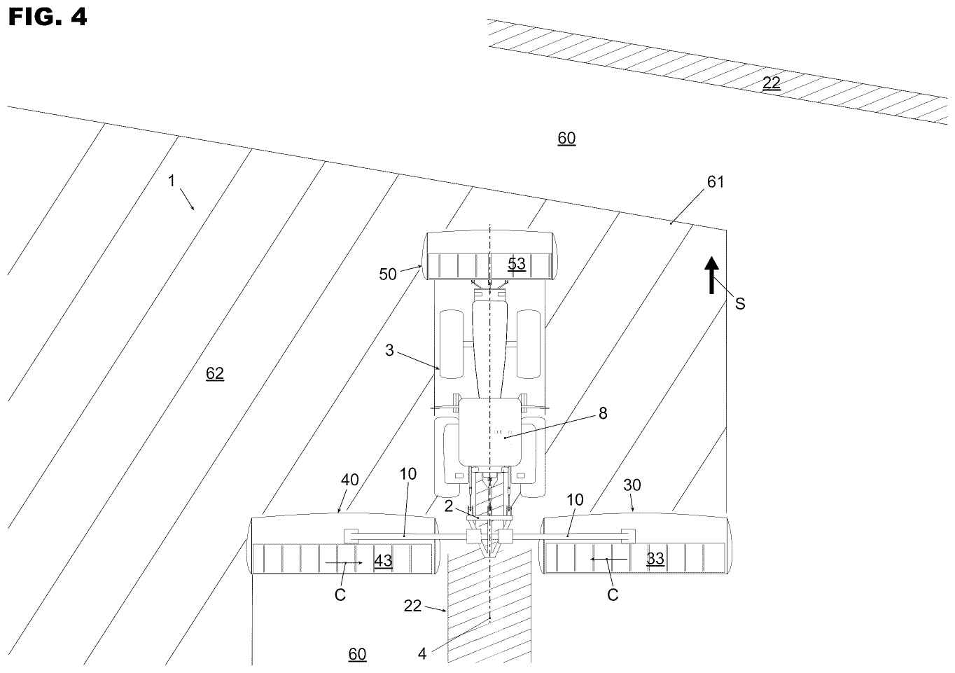

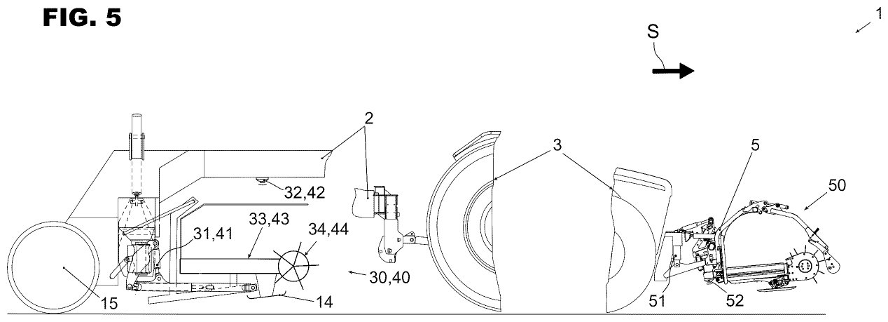

Before a unit 30,40,50 passes to a working configuration, the surface of the field constitutes a working zone 62. If a path crosses the field, for example, the path is preferentially considered as a zone to be excluded 60. As shown in FIG. 5, in the headland configuration, each unit 30,40,50 is separated from the ground. The headland configuration allows the units 30,40,50 not to work a zone, in particular a zone to be excluded 60. A zone already worked by a unit 30,40,50 is also a zone to be excluded 60. As shown in FIG. 4, the field may include at least one zone to be worked 62 and at least one zone to be excluded 60. A boundary 61 is the line between a zone to be worked 62 and a zone to be excluded 60.

In order to relieve the operator when the machine 1 has to cross a boundary 61, the controller 7 is configured to allow a lowering sequence to be executed during which each input of the same lowering command allows at least one of the units 30,40,50 to be transposed downwards. In other words, in the lowering sequence, each input of the same lowering command transposes one of the units 30,40,50 downwards. In order to relieve the operator when the machine 1 has to cross a boundary 61 in the opposite direction, the controller 7 is configured to allow a lifting sequence to be executed during which each input of the same lifting command allows at least one of the units 30,40,50 to be transposed upwards. In other words, in the lifting sequence, each input of the same lifting command transposes one of the units 30,40,50 upwards.

Thanks to these arrangements, when the machine 1 has to cross a boundary 61, the operator advantageously repeats the same command for each of the units 30,40,50, thus reducing the risk of a mistaken command. The operator, relieved of this task, can then focus more on the right moment to transpose each of the units 30,40,50 downwards or upwards in relation to the boundary 61, thus improving the accuracy of these actuations, especially when the machine 1 and/or tractor 3 do(es) not allow them to be automated, thus avoiding working twice in the same location, as well as leaving locations unworked, improving the quality of work.

In the preferred variant, the controller 7 is configured to allow a right lifting sequence to be executed. During a right lifting sequence, the first input of the lifting command transposes the central unit 50 upwards, the second input of the lifting command transposes the right-hand unit 30 upwards, and the third input of the lifting command transposes the left-hand unit 40 upwards. The right lifting sequence can be used in particular in the case of a boundary 61 and a machine 1 with an arrangement of units 30,40,50 as shown in FIG. 4.

In the preferred variant, in order to cross the boundary 61 shown in FIG. 4 in the opposite direction and with a machine 1 as shown in FIG. 4, the controller 7 is configured to allow a right lowering sequence to be executed. During a right lowering sequence, the first input of the lowering command transposes the central unit 50 downwards, the second input of the lowering command transposes the right-hand unit 30 downwards, and the third input of the lowering command transposes the left-hand unit 40 downwards. In an alternative variant, only the two right sequences (lifting and lowering) can be executed, reducing the computing capacity required in a particularly common scenario. To simplify writing, the term “right sequences” encompasses both right lifting and right lowering sequences.

In order to relieve the operator for different types of boundaries 61, in the preferred variant, the controller 7 is also configured to allow execution of left sequences (lifting and lowering). The controller 7 is thus preferentially configured to allow execution of a left lifting sequence. During a left lifting sequence, the first input of the lifting command transposes the central unit 50 upwards, the second input of the lifting command transposes the left-hand unit 40 upwards, and the third input of the lifting command transposes the right-hand unit 30 upwards. Conversely, the controller 7 is preferentially configured to allow execution of a left lowering sequence. During a left lowering sequence, the first input of the lowering command transposes the central unit 50 downwards, the second input of the lowering command transposes the left-hand unit 40 downwards, and the third input of the lowering command transposes the right-hand unit 30 downwards. For simplification, the term “left sequences” encompasses both left lifting and left lowering sequences.

In this document, once started, a sequence is said to be ongoing. In a simple and rapid manner, in the preferred variant, the controller 7 is configured so that, when no sequence is ongoing, the first input of the lowering or lifting command enables starting a sequence.

In the preferred variant, the controller 7 is also configured to allow a symmetrical lowering sequence to be executed. During a symmetrical lowering sequence, the first input of the lowering command transposes the central unit 50 downwards, and the second input of the lowering command simultaneously transposes the left-hand unit 40 and the right-hand unit 30 downwards. Lastly, in the preferred variant, the controller 7 is also configured to allow a symmetrical lifting sequence to be executed. During a symmetrical lifting sequence, the first input of the lifting command transposes the central unit 50 upwards, and the second input of the lifting command simultaneously transposes the left-hand unit 40 and the right-hand unit 30 upwards. For simplification, the term “symmetrical sequences” encompasses both symmetrical lifting and symmetrical lowering sequences.

In an alternative variant, a specific command must be entered to end a sequence even after all commands in that sequence have been input. Such a variant thus requires an additional command input for each sequence, wasting the operator's time and possibly causing an oversight which would negatively affect the quality of work. In the preferred variant, each sequence is saved with a predetermined number of commands. In other words, a predetermined number of commands is associated with each sequence. In particular, each of the left and right sequences has three commands. In addition, each of the symmetrical sequences has two commands. Therefore, each sequence has at least two commands. In a simple and rapid manner, the controller 7 is configured to end each sequence once all commands of that sequence are input. In other words, all commands in a sequence must have been input in order to be able to start another sequence. It is also stipulated that during a sequence, each unit 30,40,50 is transposed downwards or upwards only once.

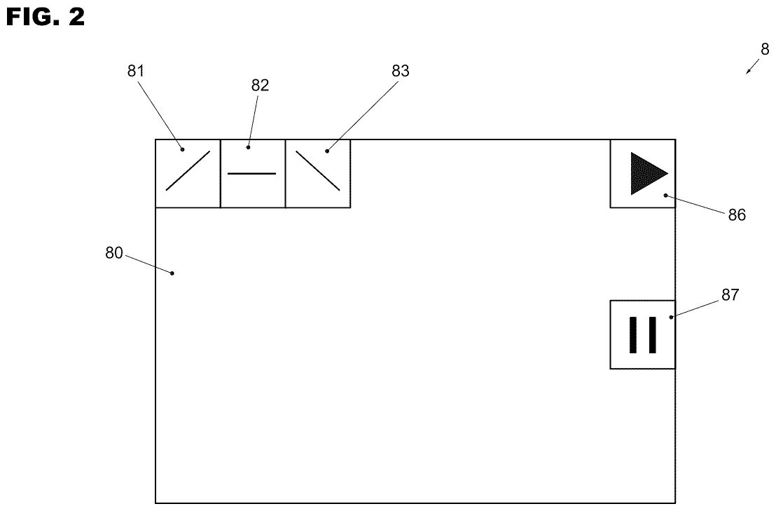

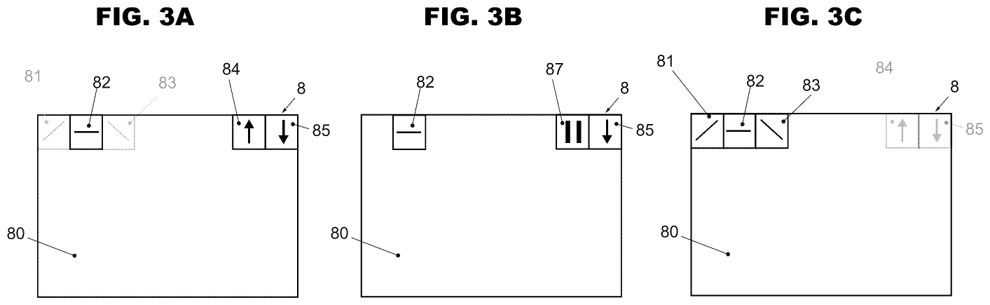

As shown in FIGS. 2 and 3, in order to input a command on the interface 8, the interface 8 is provided with a plurality of keys 81,82,83,84,85,86,87. The keys 81-87 are used to input commands. Preferentially, the keys 81-87 are actuated by the operator. Commands are therefore preferentially input by the operator. The input of a command can correspond to the actuation of one or more key(s) 81-87, respectively to the consecutive and/or simultaneous actuation of one or more key(s) 81-87.

Preferably, the interface 8 is provided with a screen 80 for displaying information about the machine 1, such as its state and/or settings. The screen 80 may be tactile and may include programmable keys 81-87. Alternatively or additionally, the interface 8 may include a joystick and/or a key unit 81-87 without a screen 80. The interface 8 may therefore include mechanical keys 81-87, on a joystick for example, and/or programmable keys 81-87 on a screen 80, all allowing commands to be input. As shown in FIG. 2, in order to more easily identify a key 81-87, a pictogram, an image and/or text is preferentially associated with each programmable key 81-87.

With a screen 80, at least one programmable key 81-87 can occupy different positions on the screen 80. In order to avoid handling errors, each key 81-87 preferentially always occupies the same position on the screen 80, at least during the same sequence.

In order to avoid unwanted actuation, at least one key 81-87 of the interface 8 can be deactivated. When a key 81-87 is deactivated, its actuation has no effect. Furthermore, especially in the case of an interface 8 with a screen 80, at least one key 81-87 of the interface 8 can be displayed differently to the others. Therefore, when a programmable key 81-87 is deactivated, it is preferentially displayed differently, advantageously informing the operator about the active keys 81-87, respectively about the deactivated keys 81-87, at a specific moment. In the preferred variant, each key 81-87 can therefore have a first appearance and a second appearance. Preferentially, a key 81-87 with the first appearance is an active key 81-87. An active key 81-87 is a key 81-87 that is not deactivated. As shown in FIG. 2, a key 81-87 with the first appearance may in particular have solid lines, strong contrast, and/or a first color. Preferentially, a key 81-87 with the second appearance is a deactivated key 81-87. A key 81-87 with the second appearance may have a second color or be hidden. As shown in FIG. 3B, the left 81 and right 83 selection keys are hidden as they are deactivated. Such arrangements advantageously reduce the risk of mistakes when pressing the key 81-87. Each key 81-87 can also have a third appearance, preferentially when it is active but for which the command (or function) is not ongoing, making it possible to further inform the operator about the status of the machine 1. A key 81-87 with the third appearance may in particular have dashed, grayed out lines and/or a third color. In the example of FIG. 3A, the left 81 and right 83 selection keys have the third appearance because they are active and the ongoing command is the symmetrical mode associated with the symmetrical selection key 82.

In a first embodiment variant not shown in the figures, in order to transpose the units 30,40,50 upwards during a right lifting sequence, each input of the lifting command corresponds to the actuation of a right lifting key. Similarly, in this first embodiment variant, in order to transpose the units 30,40,50 downwards during a right lowering sequence, each input of the lowering command corresponds to the actuation of a right lowering key 85.

In the first embodiment, in order to transpose the units 30,40,50 upwards during a left lifting sequence, each input of the lifting command corresponds to the actuation of a left lifting key. In the first variant, in order to transpose the units 30,40,50 downwards during a left lowering sequence, each input of the lowering command corresponds to the actuation of a left lowering key 85.

Still in the first variant, in order to transpose the units 30,40,50 upwards during a symmetrical lifting sequence, each input of the lifting command corresponds to the actuation of a symmetrical lifting key. In the first variant, in order to transpose the units 30,40,50 downwards during a symmetrical lowering sequence, each input of the lowering command corresponds to the actuation of a symmetrical lowering key 85.

Therefore, in the first variant, the interface 8 must have at least six keys 81-87 intended to transpose the units 30,40,50 downwards and upwards in the case where six sequences are saved, namely two left, two right and two symmetrical sequences. A disadvantage of this first variant is therefore that it requires a large number of keys 81-87, which may cause confusion for the operator when choosing the sequence and increase the risk of the operator selecting the wrong key. This is especially the case since, when crossing a boundary 61, the operator is often required to make a U-turn and must therefore focus on other commands.

In order to allow the operator to choose the next sequence in advance, thereby reducing the risk of them selecting the wrong key 81-87 and allowing them to focus more on driving and/or other tasks or commands when crossing a boundary 61, in the preferred variant, a right mode is associated with the right sequences and a left mode is associated with the left sequences. In the preferred variant, a symmetrical mode is associated with the symmetrical sequences.

Advantageously, the controller 7 is configured to allow entry into the right mode in which only the right sequences can be executed. In addition, the controller 7 is configured to allow entry into the left mode in which only the left sequences can be executed. In the preferred variant, the controller 7 is configured to allow entry into the right mode through the input of a right selection command, and into the left mode through the input of a left selection command. Still in the preferred variant, the controller 7 is configured to allow entry into the symmetrical mode through the input of a symmetrical selection command. It is stipulated that no selection command input allows a unit 30,40,50 to be transposed upwards or downwards. With this arrangement, it is possible to enter one or each mode before reaching a boundary 61. After entering a mode, this mode is said to be ongoing. It is therefore possible to enter one or each mode without starting a sequence or transposing a unit 30,40,50 upwards or downwards. Being able to enter a mode in advance gives the operator more time to make their choice, avoiding handling errors, and allowing them to focus more on the other commands. In the case of a screen 80, the number of keys 81-87 can be further reduced, at least when no sequence is ongoing.

As shown in FIG. 2, the interface 8 is provided with a right selection key 83 associated with the right mode and a left selection key 81 associated with the left mode. Preferentially, the interface 8 is also provided with a symmetrical selection key 82. The interface 8 is thus provided with selection keys 81-83, each associated with a respective mode. In the preferred variant, the interface 8 is provided with at least three selection keys 81-83. The controller 7 is configured so that the selection keys 81,82,83 are preferentially deactivated when a sequence is ongoing, thereby ensuring that the ongoing sequence is completed before starting another one. In order for the interface 8 to inform the operator of the ongoing mode, the controller 7 is configured so that when it enters a mode, the selection key 81,82,83 associated with this mode is displayed differently to the other selection keys 81,82,83. For example, when the controller 7 enters a mode, the selection key 81,82,83 corresponding to that mode is the only one displayed on the screen 80, the other selection keys 81,82,83 being hidden, or respectively with the second appearance. Alternatively or additionally, when a deactivated key 81-87 is actuated, the controller 7 can be configured to issue a warning, thereby avoiding a handling error and improving the quality of work. The warning can be audible and/or visual. Alternatively or additionally, for a tactile screen 80, if the operator touches it next to an active key 81-87, the controller 7 may also be configured to issue a warning.

In a simple and rapid manner, in the preferred variant, each selection command corresponds to the actuation of a single respective selection key 81,82,83 only. In the preferred variant, input of the right selection command corresponds to the actuation of the right selection key 83 only, and input of the left selection command corresponds to the actuation of the left selection key 81 only. Similarly, the input of the symmetrical selection command corresponds to the actuation of the symmetrical selection key 82 only. In an alternative variant, the selection command corresponds to the consecutive and/or simultaneous actuation of one or more key(s) 81-87.

Thanks to the possibility of entering a mode, each of the lowering and lifting commands can be identical, regardless of the ongoing mode. As such, the interface 8 can be provided with a lifting key 84 and a lowering key 85. Therefore, in the preferred variant, the controller 7 is configured so that the input of the lowering command corresponds to a single actuation of the lowering key 85 only, whatever the ongoing mode. Similarly, the controller 7 is configured so that the input of the lifting command corresponds preferentially to a single actuation of the lifting key 84 only, whatever the ongoing mode. Such arrangements make it possible to reduce the number of keys, respectively the number of active keys, at least when no sequence is ongoing, thus further reducing the risk of a handling error.

It follows from the above that, in the preferred variant, the left selection key 81 is associated with the left mode, and the right selection key 83 is associated with the right mode. In the preferred variant, the symmetrical selection key 82 is associated with the symmetrical mode. Therefore, when no sequence is ongoing, if a selection command is input, respectively if a selection key 81,82,83 is actuated, the controller 7 is configured to enter the corresponding mode.

In a simple and rapid manner, after a sequence, if no other mode is selected by a selection command, respectively by a selection key 81,82,83, the last mode entered remains ongoing. In other words, the controller 7 is configured so that, when no sequence is ongoing, if no other mode is selected, the next input of a lowering or lifting command, respectively the next actuation of one of the lowering 84 or lifting 84 keys, starts a new sequence of the last mode into which the controller 7 entered.

As shown in FIG. 5, in the preferred variant, a configuration sensor 32,42,52 is associated with each unit 30,40,50. Specifically, a right-hand configuration sensor 32 is associated with the right-hand unit 31, a left-hand configuration sensor 42 is associated with the left-hand unit 41, and a central configuration sensor 52 is associated with the central unit 51. Each configuration sensor 32,42,52 at least detects whether the associated unit 30,40,50 is in the working or headland configuration. In addition, each configuration sensor 32,42,52 can inform the controller 7 about the configuration of the associated unit 30,40,50.

The lowering 84 and raising 84 keys are preferentially both displayed on the screen 80 until the start of a sequence. In this preferred variant, as soon as a sequence is started by the actuation of one of the lifting 84 and lowering 84 keys, the other (of the lifting 84 and lowering 84 keys) is no longer displayed (see FIG. 3B), reducing the number of keys 81-87, respectively the number of active keys, and reducing the risk of a handling error. In addition, the screen 80, if applicable, thus informs the operator of the ongoing sequence.

In the preferred variant, the controller 7 is configured such that if, at the start of a sequence, the configuration sensors 32,42,52 inform the controller 7 that all units 30,40,50 are in the working configuration, the lowering key 85 is deactivated. In the preferred variant, the controller 7 is configured such that if, at the start of a sequence, the configuration sensors 32,42,52 inform the controller 7 that all units 30,40,50 are in the working configuration, the lowering key 85 is displayed differently to the lifting key 84. In this case, the lowering key 85 has the second appearance, respectively is not displayed if the interface 8 has a screen 80. Similarly, if at the start of a sequence the configuration sensors 32,42,52 inform the controller 7 that all units 30,40,50 are in the headland configuration, the lifting key 84 is deactivated. In the preferred variant, the controller 7 is configured such that if, at the start of a sequence, the configuration sensors 32,42,52 inform the controller 7 that all units 30,40,50 are in the headland configuration, the lifting key 84 is displayed differently to the lowering key 85. In this case, the lifting key 84 has the second appearance, respectively is not displayed if the interface 8 has a screen 8. In FIG. 3B, the lifting key 84 has thus been hidden. Such arrangements reduce the risk of a handling error, and the number of keys 81-87 displayed on the screen 80 if applicable. Furthermore, these arrangements make it possible to inform the operator when all units 30,40,50 are in the same configuration at the start of a sequence. Also, in the preferred variant, the controller 7 is configured such that, at the start of a sequence, if the configuration sensors 32,42,52 inform the controller 7 that all units 30,40,50 are in the same configuration, one of the lifting 84 and lowering keys 85 is deactivated, thereby reducing the number of keys 81-87 active at the start of a sequence. Preferentially, at the start of a sequence, if the configuration sensors 32,42,52 inform the controller 7 that all units 30,40,50 are in the same configuration, the controller 7 is configured such that the lifting 84 and lowering 84 keys are displayed differently, thereby reducing the risk of selecting the wrong key.

If the machine 1 is equipped with configuration sensors 32,42,52, at the start of a sequence, if all units 30,40,50 are not in the same configuration, the lifting 84 and lowering 84 keys are preferentially both displayed, allowing the next sequence to be determined. If the machine 1 is equipped with configuration sensors 32,42,52, when a mode is ongoing and when, at the start of a sequence, all units 30,40,50 are not in the same configuration, the controller 7 is configured such that the first command input determines the next sequence. Therefore, when a mode is ongoing and when, at the start of the sequence, all units 30,40,50 are not in the same configuration, if the first input is a lifting command input, then the sequence started is a lifting sequence. Conversely, when a mode is ongoing and when, at the start of the sequence, all units 30,40,50 are not in the same configuration, if the first input is a lowering command input, then the sequence started is a lowering sequence.

Alternatively, if one unit 30,40,50 is in a different configuration to the other two units 30,40,50, then the next sequence will be determined by the configuration of the two units 30,40,50 that are in the same configuration.

As shown in FIG. 2, in a second alternative embodiment variant during which the machine 1 is equipped with configuration sensors 32,42,52, when a mode is ongoing, only a common action key 86 is active. In the second variant, the controller 7 is configured such that when a mode is ongoing and when, at the start of a sequence, the configuration sensors 32,42,52 inform the controller 7 that all units 30,40,50 are in the headland configuration, each actuation of the common action key 86 transposes at least one unit 30,40,50 downwards. In this second variant, the controller 7 is also configured such that when a mode is ongoing and when, at the start of a sequence, the configuration sensors 32,42,52 inform the controller 7 that all units 30,40,50 are in the working configuration, each actuation of the common action key 86 transposes at least one unit 30,40,50 upwards. Therefore, in the second variant, the lowering command and the lifting command are identical, thus further reducing the number of keys 81-87 and the risk of a handling error.

In a simple and rapid manner, in the preferred variant, the controller 7 is configured such that the start of a sequence corresponds to the first input of a lowering command or a lifting command, regardless of the ongoing mode. In other words, in the preferred variant, when a mode is ongoing but there is no ongoing sequence, the controller 7 is configured such that the first input of the lowering or lifting command starts the corresponding sequence and transposes at least one of the units 30,40,50 downwards or upwards. Alternatively, when a mode is ongoing but there is no ongoing sequence, the controller 7 is configured such that an additional command input before the first input of the lowering or lifting command starts the sequence.

The interface 8 may also include a stop key 87. The stop key 87 is used to stop the ongoing sequence. For safety purposes, actuation of the stop key 87 immediately stops any lifting and/or lowering of the unit(s) 30,40,50. If the stop key 87 is actuated a second time during a sequence, the sequence resumes normally.

With a screen 80, the stop key 87 appears preferentially on the screen 80 after starting the sequence, and is preferentially hidden at the end of the sequence. With an interface 8 with a screen 80, during a sequence, the stop key 87 can replace whichever of the lifting key 84 or the lowering key 85 was hidden at the start of the ongoing sequence. Preferably, when a key 81-87 is displayed on the screen 80, it always occupies the same position, with the exception of the stop key 87.

Alternatively or additionally, if during a sequence a lifting command is input while the unit 30,40,50 in question is in the headland configuration, this lifting command has no effect (and the unit 30,40,50 in question remains in the headland configuration). In turn, if during a sequence a lowering command is input while the unit 30,40,50 in question is in the working configuration, this lowering command has no effect (and the unit 30,40,50 in question remains in the working configuration).

The controller 7 can be installed either on the tractor 3 or on the machine 1. The controller 7 and/or the interface 8 may be part of the machine 1 or tractor 3. Alternatively, the interface 8 and the controller 7 may be a single component. The machine 1 is connected to the tractor 3 via a standardized bus connection, for example ISOBUS (ISO 11783), allowing the machine 1 to operate with different tractor 3 brands and/or components (interface 8, controller 7, etc.). The controller 7 can thus also receive a signal representative of the speed of advance of the machine 1. The signal representing the speed of advance of the machine 1 can be obtained by at least one GPS sensor, a speed sensor mounted on the machine 1 and/or a tractor speed sensor 3.

In FIGS. 1, 4 and 5, the central unit 50 is located in front of the left-hand 40 and right-hand 30 units as seen from above. In these figures, the central unit 50 is located in front of the tractor 3, thus avoiding rolling over a zone to be worked 62. As shown in FIGS. 1 and 4, in order to ensure working of the entire field, even during turns, the central unit 50 is located partially between the left-hand unit 40 and the right-hand unit 30 as viewed in the working direction S. In other words, when viewed in the working direction S, the central unit 50 slightly overlaps each of the left-hand 40 and right-hand 30 units. Preferably, these overlaps can be adjusted, simultaneously and/or separately. The central unit 50 can also be located completely between the left-hand unit 40 and the right-hand unit 30 as viewed in the working direction S.

As shown in FIG. 1, the chassis 2 can be mounted on wheels 15. The wheels 15 are preferentially located at the rear of the chassis 2. Furthermore, in the working configuration, each unit 30,40,50 rests at least partially on the ground via pads 14. Alternatively or additionally, each unit 30,40,50 can rest on the ground via casters. In the working configuration, each unit 30,40,50 is configured to harvest the product.

When the product is deposited by a unit 30,40,50, respectively by a grouping device 33,43,53, the product forms a swath 22 on the ground due to the movement of the machine 1 in the working direction S. The swath 22 is therefore longitudinal to the working direction S. As shown in FIG. 4, the right-hand 33 and left-hand 43 grouping devices move the product towards the midplane 4, with the swath 22 deposited between the right-hand unit 30 and the left-hand unit 40. To this end, in their working configuration, the left-hand 40 and right-hand 30 units are separated from each other in a direction perpendicular to the working direction S. The right-hand 33 and left-hand 43 grouping devices are preferentially aligned in the grouping direction C, reducing the length of the machine 1 in the working direction S.

In the headland configuration, each unit 30,40,50 is further from the ground than in the working configuration. In the headland configuration, each unit 30,40,50 is slightly separated from the ground, so that movement between the working and headland configurations is as fast as possible. In the headland configuration, each unit 30,40,50 does not harvest any product. In particular, the headland configuration allows the machine 1 to move over an already worked zone without damaging the swaths.

The units 30,40,50 may also occupy a transport configuration. In their transport configuration, the dimension of the left-hand 30 and right-hand 40 units as viewed in the working direction S is reduced. In their transport configuration, each left-hand 30 and right-hand 40 unit is oriented parallel to the midplane 4, reducing the width of the machine 1. In order to minimize the height of the machine 1 in the transport configuration, the left-hand 30 and right-hand 40 units are preferentially oriented parallel to the working direction S. In their transport configuration, the units 30,40,50 are separated from the ground, allowing a higher speed of advance without risking damage to the machine 1. The transport configuration of the central unit 50 is preferentially identical to the headland configuration.

In the preferred variant, each actuator 31,41,51 also allows the associated unit 30,40,50 to be transposed between the headland configuration and the transport configuration, and/or between the working configuration and the transport configuration. In the preferred variant, each configuration sensor 32,42,52 also detects whether the associated unit 30,40,50 is in a working, headland or transport configuration. In the preferred variant if, at the start of a sequence, a configuration sensor 32,42,52 informs the controller 7 that the associated unit 30,40,50 is in the transport configuration, the controller 7 is configured so that the associated unit 30,40,50 is neither transposed upwards nor downwards during this sequence.

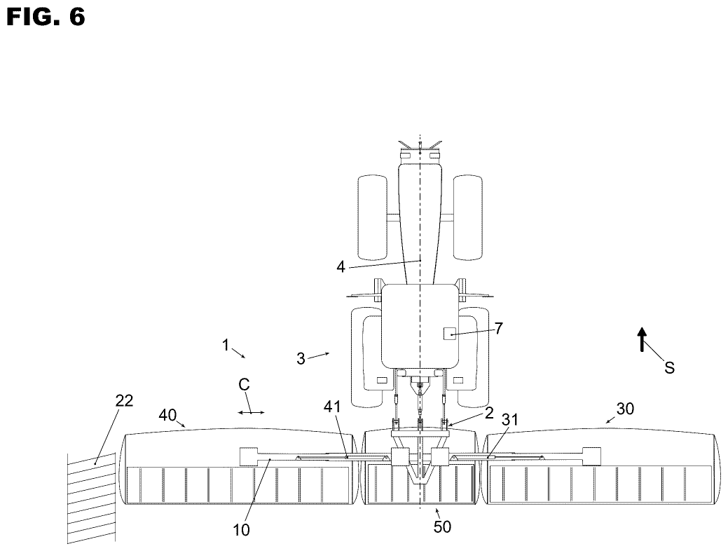

As mentioned earlier in this description, other arrangements of the units 30,40,50 on the machine 1 are possible. By way of example, a machine 1 with another possible arrangement of the units 30,40,50 is shown in FIG. 6. In this FIG. 6, the central 50, left-hand 40 and right-hand 30 units are aligned along a straight line transverse to the working direction S, and the central unit 50 is connected to the same chassis 2 as the left-hand 40 and right-hand 30 units. Preferentially, the units 30,40,50 are aligned perpendicular to the working direction S. In the case of a machine 1 as shown in FIG. 6, the pre-saved sequences may be different to those with an arrangement of units 30,40,50 as shown in FIG. 4.

Therefore, in order to adapt to a different type of boundary 61 and/or a different arrangement of the units 30,40,50, the controller 7 may be configured to allow the execution of an alternative left lowering sequence during which the first input of the lowering command transposes the left-hand unit 30 downwards, the second input of the lowering command transposes the central unit 50 downwards, and the third input of the lowering command transposes the right-hand unit 40 downwards. For the same purpose, the controller 7 may be configured to allow the execution of an alternative left lifting sequence during which the first input of the lifting command transposes the left-hand unit 30 upwards, the second input of the lifting command transposes the central unit 50 upwards, and the third input of the lifting command transposes the right-hand unit 40 upwards.

In addition, in order to adapt to a different type of boundary 61 and/or a different arrangement of the units 30,40,50, the controller 7 may be configured to allow the execution of an alternative right lowering sequence during which the first input of the lowering command transposes the right-hand unit 40 downwards, the second input of the lowering command transposes the central unit 50 downwards, and the third input of the lowering command transposes the left-hand unit 30 downwards. For the same purpose, the controller 7 may be configured to allow the execution of an alternative left lifting sequence during which the first input of the lifting command transposes the right-hand unit 40 upwards, the second input of the lifting command transposes the central unit 50 upwards, and the third input of the lifting command transposes the left-hand unit 30 upwards.

In order to adapt to other types of boundary 61 and/or other arrangements of the units 30,40,50, the controller 7 may also be configured to allow the execution of other sequences.

The invention also concerns a controller 7 for a harvesting machine 1 as described above. The controller 7 is configured to allow each unit 30,40,50 of a machine 1 as described above to be transposed downwards or upwards. In addition, the controller 7 is configured to execute a lowering sequence and a lifting sequence as described above. Preferably, each sequence is saved in a memory MS. The memory MS may be part of the controller 7. In the preferred variant, the controller 7 includes a memory MS and a processor. Alternatively, each sequence may be saved in an external memory MS connected to the controller 7. Furthermore, the invention may also relate to a computer program containing a code for transposing each unit 30,40,50 of a machine 1 as described above downwards or upwards. In addition, the computer program contains a code allowing to execute a lowering sequence and a lifting sequence as described above.

Of course, the invention is not limited to the embodiments described and represented in the attached drawings, and broken down in several construction variants. Modifications remain possible, in particular as regards the composition of the various elements or the substitution by technical equivalents without departing from the scope of protection of the invention.

1. An harvesting machine moving in a working direction and including a right-hand unit, a left-hand unit and a central unit extending at least mainly between the left-hand unit and the right-hand unit viewed in the working direction, each unit being able to occupy a working configuration and a headland configuration, an interface for inputting commands being associated with the machine and connected to a controller able to transpose each unit downwards, which means to transpose each unit from the headland configuration to the working configuration, and to transpose each unit upwards, which means to transpose each unit from the working configuration to the headland configuration, wherein the controller is configured to allow execution of a lowering sequence during which each input of a same lowering command transposes at least one of the units downwards, and a lifting sequence during which each input of a same lifting command transposes at least one of the units upwards.

2. The harvesting machine according to claim 1, wherein the controller is configured to allow the execution of a right lifting sequence during which the first input of the lifting command transposes the central unit upwards, the second input of the lifting command transposes the right-hand unit upwards, and the third input of the lifting command transposes the left-hand unit upwards.

3. The harvesting machine according to claim 1, wherein the controller is configured to allow the execution of a right lowering sequence during which the first input of the lowering command transposes the central unit downwards, the second input of the lowering command transposes the right-hand unit downwards, and the third input of the lowering command transposes the left-hand unit downwards.

4. The harvesting machine according to claim 1, wherein the controller is configured to allow the execution of a left lifting sequence during which the first input of the lifting command transposes the central unit upwards, the second input of the lifting command transposes the left-hand unit upwards, and the third input of the lifting command transposes the right-hand unit upwards.

5. The harvesting machine according to claim 1, wherein the controller is configured to allow the execution of a left lowering sequence during which the first input of the lowering command transposes the central unit downwards, the second input of the lowering command transposes the left-hand unit downwards, and the third input of the lowering command transposes the right-hand unit downwards.

6. The harvesting machine according to claim 1, wherein a predetermined number of commands is associated with each sequence, and wherein the controller is configured to end each sequence once all commands of that sequence are input.

7. The harvesting machine according to claim 6, wherein the controller is configured to allow entry into a right mode in which only the right sequences can be executed and to allow entry into a left mode in which only the left sequences can be executed.

8. The harvesting machine according to claim 7, wherein the interface is provided with selection keys, each associated with a respective mode, the controller being configured so that the selection keys are deactivated when a sequence is ongoing.

9. The harvesting machine according to claim 7, wherein the interface is provided with a lifting key and a lowering key, and wherein the controller is configured so that the input of the lowering command corresponds to a single actuation of the lowering key only, whatever of the ongoing mode, and so that the input of the lifting command corresponds to a single actuation of the lifting key only, whatever of the ongoing mode.

10. The harvesting machine according to claim 8, wherein a configuration sensor is associated with each unit, each configuration sensor detects whether the associated unit is in the working or headland configuration, and wherein the controller is configured such that at the start of a sequence, if the configuration sensors inform the controller that all units are in the same configuration, one of the lifting and lowering keys is deactivated.

11. The harvesting machine according to claim 1, wherein the controller is configured so that, when no sequence is ongoing, the first input of the lowering or lifting command enables starting a sequence.

12. A controller for a harvesting machine wherein the controller is configured to allow a lowering and lifting sequence according to claim 1.

13. A computer program for a harvesting machine, wherein it contains a code allowing to execute a lowering and lifting sequence according claim 1.
